(19) United States
(12) Patent Application Publication
(10) Pub. No.: US 2014/0285795 A1
(43) Pub. Date: Sep. 25, 2014

(54) DOWNHOLE MULTIPLE CORE OPTICAL SENSING SYSTEM

(71) Applicant: HALLIBURTON ENERGY SERVICES, INC., Houston, TX (US)

(72) Inventors: Mikko JAASKELAINEN, Katy, TX (US); Ian B. MITCHELL, Katy, TX (US)

(73) Assignee: Halliburton Energy Services, Inc., Houston, TX (US)

(21) Appl. No.: 13/847,165

(22) Filed: Mar. 19, 2013

(51) Int. Cl. G01V 8/00

(52) U.S. Cl. CPC G01V 8/00
USPC 356/73.1

(57) ABSTRACT

A downhole optical sensing system can include an optical fiber positioned in the well, the optical fiber including multiple cores, and at least one well parameter being sensed in response to light being transmitted via at least one of the multiple cores in the well. The multiple cores can include a single mode core surrounded by a multiple mode core. A method of sensing at least one well parameter in a subterranean well can include transmitting light via at least one of multiple cores of an optical fiber in the well, the at least one of the multiple cores being optically coupled to a sensor in the well, and/or the at least one of the multiple cores comprising a sensor in the well, and determining the at least one well parameter based on the transmitted light.

### BACKGROUND

This disclosure relates generally to equipment utilized and operations performed in conjunction with a subterranean well and, in an example described below, more particularly provides to the art a downhole multiple core optical sensing system.

The application of this disclosure's principles to subterranean wells is beneficial, because it is useful to monitor dynamic wellbore conditions (e.g., pressure, temperature, strain, etc.) during various stages of well construction and operation. However, pressures and temperatures in a wellbore can exceed the capabilities of conventional piezoelectric and electronic pressure sensors. Optical fibers, on the other hand, have greater temperature capability, corrosion resistance and electromagnetic insensitivity as compared to conventional sensors.

Therefore, it will be appreciated that advancements are needed in the art of measuring downhole parameters with optical sensing systems.

### BRIEF DESCRIPTION OF THE DRAWINGS

FIG. 1 is a representative partially cross-sectional view of a downhole sensing system and associated method which can embody principles of this disclosure.

FIG. 2 is a representative cross-sectional view of a multiple core optical fiber which may be used in the system and method of FIG. 1.

FIG. 3 is a representative cross-sectional view of another example of the multiple core optical fiber.

FIG. 4 is a representative schematic view of the multiple core optical fiber utilized in the downhole sensing system.

FIG. 5 is a representative schematic view of another example of the multiple core optical fiber utilized in the downhole sensing system.

FIG. 6 is a representative schematic view of another example of the downhole sensing system.

### DETAILED DESCRIPTION

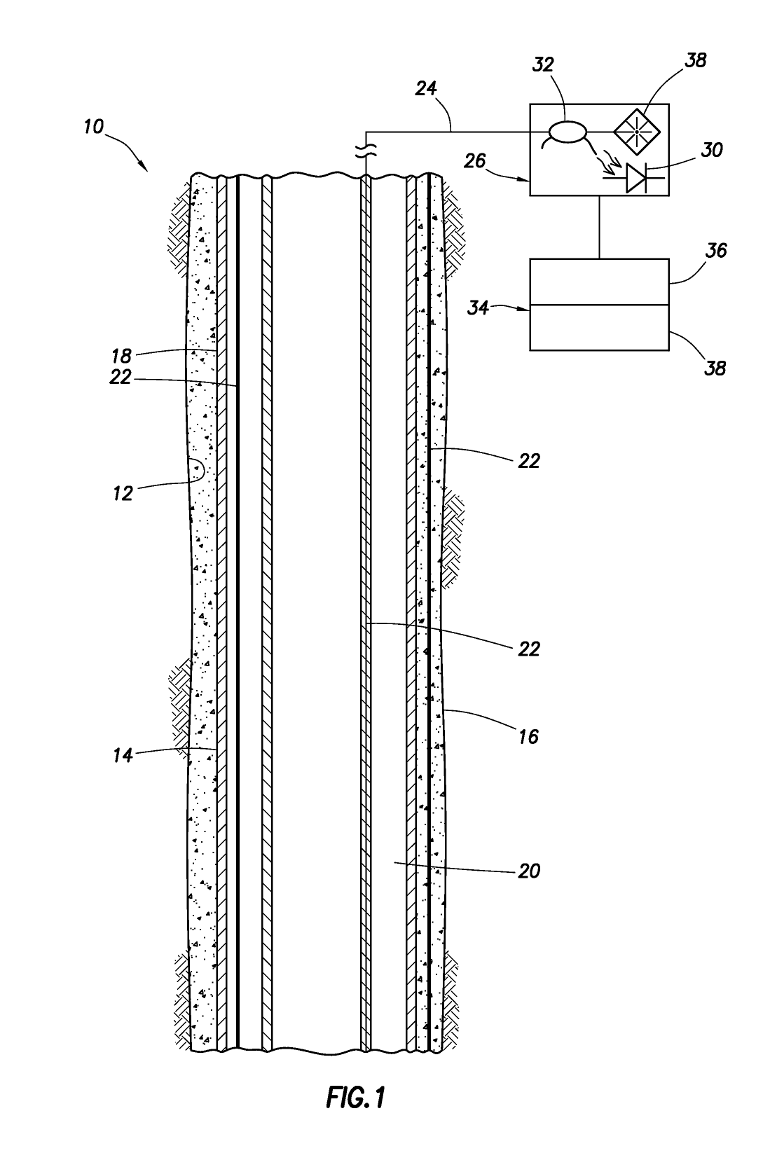

Representatively illustrated in FIG. 1 is a downhole optical sensing system 10, and an associated method, which system and method can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a wellbore 12 is lined with casing 14 and cement 16. A tubular string 18 (such as, a coiled tubing or production tubing string) is positioned in the casing 14.

The system 10 may be used while producing and/or injecting fluids in the well. Well parameters (such as pressure, temperature, resistivity, chemical composition, flow rate, etc.) along the wellbore 12 can vary for a variety of different reasons (e.g., a particular production or injection activity, different fluid densities, pressure signals transmitted via an interior of the tubular string 18 or an annulus 20 between the tubular string and the casing 14, etc.). Thus, it will be appreciated that the scope of this disclosure is not limited to any particular use for the well, to any particular reason for determining any particular well parameter, or to measurement of any well parameter in the well.

Optical cables 22 are depicted in FIG. 1 as extending longitudinally through the wellbore 12 via a wall of the tubular string 18, in the annulus 20 between the tubular string and the casing 14, and in the cement 16 external to the casing 14. These positions are merely shown as examples of optical cable positions, but any position may be used as appropriate for the circumstances (for example, attached to an exterior of the tubular string 18, etc.).

The cables 22 may include any combination of lines (such as, optical, electrical and hydraulic lines), reinforcement, etc. The scope of this disclosure is not limited to use of any particular type of cable in a well.

An optical waveguide (such as, an optical fiber 24, optical ribbon, etc.) of each cable 22 is optically coupled to an optical interrogator 26. In this example, the interrogator 26 includes at least a light source 28 (such as, a tunable laser), an optical detector 30 (such as, a photodiode or other type of photo-detector or optical transducer), and an optical coupler 32 for launching light into the fiber 24 from the source 28 and directing returned light to the detector 30. However, the scope of this disclosure is not limited to use of any particular type of optical interrogator including any particular combination of optical components.

A control system 34, including at least a controller 36 and a computing device 38 may be used to control operation of the interrogator 26. The computing device 38 (such as, a computer including at least a processor and memory) may be used to determine when and how the interrogator 26 should be operated, and the controller 36 may be used to operate the interrogator as determined by the computing device. Measurements made by the optical detector 30 may be recorded in memory of the computing device 38.

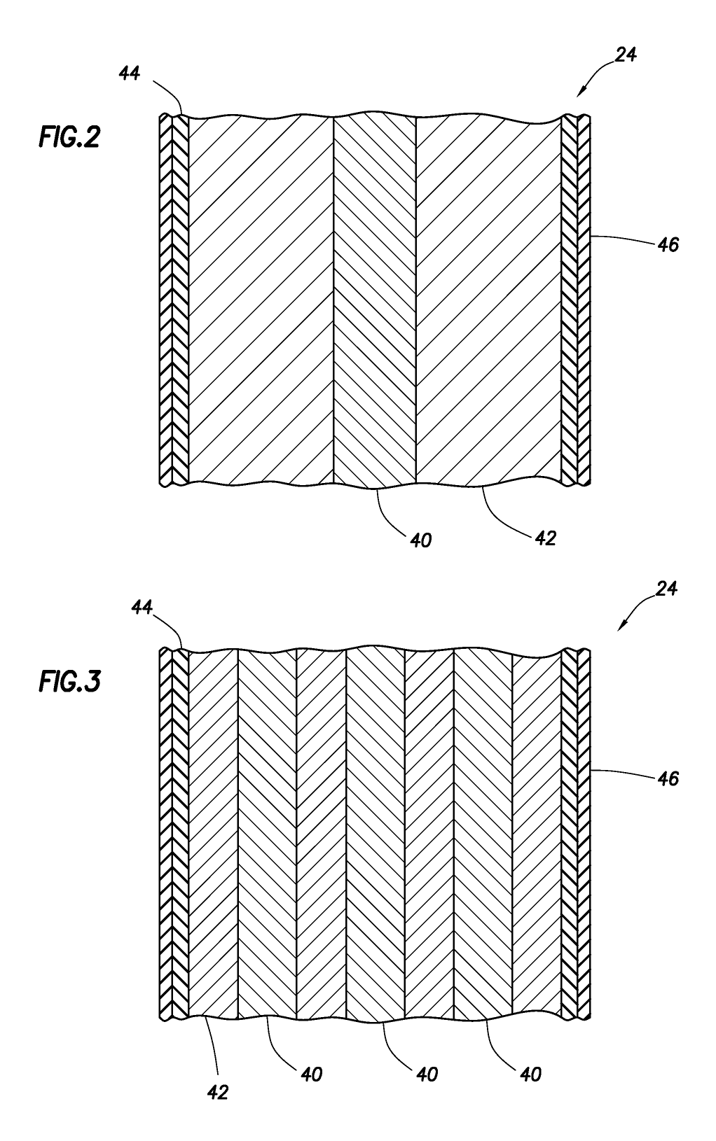

Referring additionally now to FIG. 2, an enlarged scale cross-sectional view of a longitudinal section of the optical fiber 24 is representatively illustrated. In this view, it may be seen that the optical fiber 24 includes an inner core 40 surrounded by an outer core (or inner cladding) 42. The outer core 42 is surrounded by an outer cladding 44 and a protective polymer jacket 46.

Although only two cores 40, 42 are depicted in FIG. 2, any number or combination of cores may be used in other examples. Although the cores 40, 42 and other elements of the optical fiber 24 are depicted as being substantially cylindrical or annular in shape, other shapes may be used, as desired. Thus, the scope of this disclosure is not limited to the details of the optical fiber 24 as depicted in the drawings or described herein.

In one example of application of the optical fiber 24 in the system 10 described above, one of the cores 40, 42 can be used in sensing one well parameter, and the other of the cores can be used in sensing another well parameter. The well parameters can be sensed with individual sensors at discrete locations (for example, optical sensors based on fiber Bragg gratings, interferometers, etc.), or the well parameters can be sensed as distributed along the optical fiber (for example, using the fiber itself as a sensor by detecting scattering of light in the fiber).

The inner and outer cores 40, 42 may be single mode or multiple mode. Thus, the optical fiber 24 can include one or more single mode core(s), one or more multiple mode core(s), and/or any combination of single and multiple mode cores. In one example, the inner core 40 can be single mode and the outer core 42 can be a multiple mode core.

Referring additionally now to FIG. 3, another example of the optical fiber 24 is representatively illustrated. In this example, the optical fiber 24 includes multiple inner cores 40. Although two cores 40, 42 are depicted in FIG. 2 and four cores are depicted in FIG. 3, it should be clearly understood that any number of cores may be used in the optical fiber 24 in keeping with the scope of this disclosure.

By using multiple cores 40, 42 in the optical fiber 24, fewer optical fibers are needed to sense a given number of well parameters. This reduces the number of penetrations through pressure bulkheads in the well, and simplifies installation of downhole sensing systems.

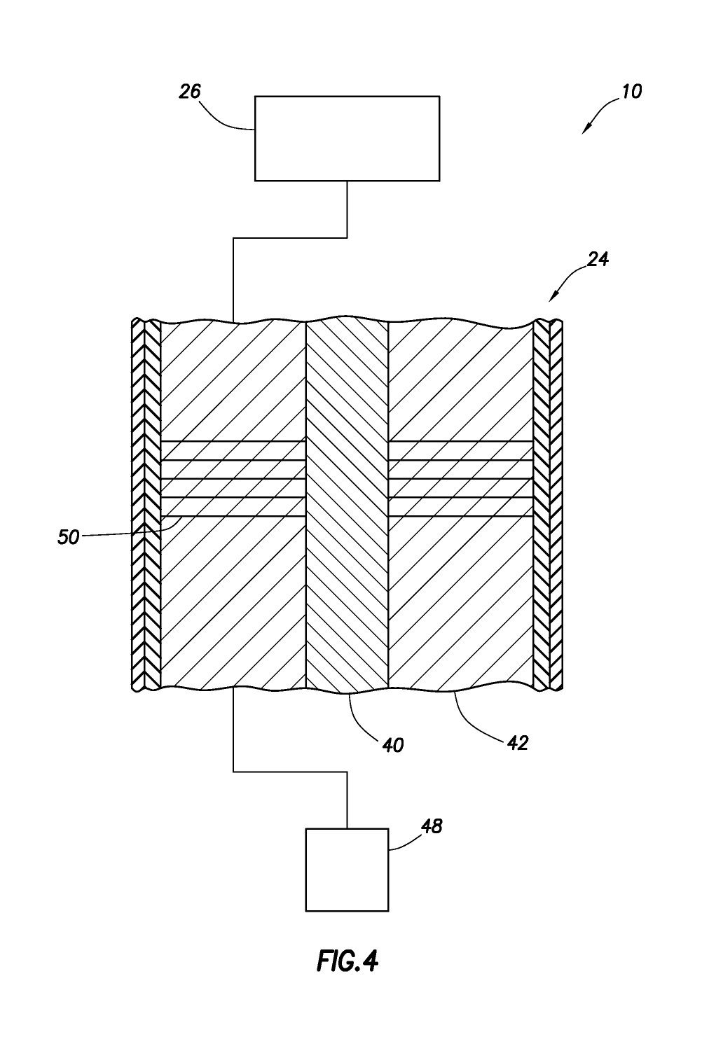

Referring additionally now to FIG. 4, an example of the multiple core optical fiber 24 being used in the system 10 is schematically and representatively illustrated. In this example, the core 42 is used for sensing at least one well parameter.

The interrogator 26 is optically coupled to the core 42, for example, at the earth's surface, a subsea location, another remote location, etc. One or more downhole sensor(s) 48 may be optically coupled to the core 42 in the well.

The downhole sensor 48 can comprise any type of sensor capable of being optically coupled to the fiber 24 for optical transmission of well parameter indications via the fiber. For example, optical sensors based on fiber Bragg gratings, intrinsic or extrinsic interferometers (such as Michelson, Fabry-Perot, Mach-Zehnder, Sagnac, etc.) may be used to sense strain, pressure, temperature, vibration and/or other well parameters. Such optical sensors are well known to those skilled in the art, and so will not be described further here.

The core 42 itself may comprise a downhole sensor. For example, the interrogator 26 may detect scattering of light launched into the core 42 as an indication of various well parameters (strain, temperature, pressure, vibration, acoustic energy, etc.) as distributed along the optical fiber 24. Thus, the core 42 can comprise a sensor in a distributed temperature, distributed pressure, distributed strain, distributed vibration and/or distributed acoustic sensing system (DTS, DPS, DSS, DVS and DAS, respectively).

The type of light scattering detected can vary based on the distributed well parameter being measured. For example, Raman, Rayleigh, coherent Rayleigh, Brillouin and/or stimulated Brillouin scattering may be detected by the interrogator 26. Techniques for determining parameters based on light scattering as distributed along an optical fiber are well known to those skilled in the art, and so these techniques are not further described herein.

Another method for using the core 42 as a sensor in the well is depicted in FIG. 4. A fiber Bragg grating 50 is etched in the core 42. The fiber Bragg grating 50 could, for example, be part of an intrinsic Fabry-Perot interferometer used to measure strain, pressure, temperature, etc.

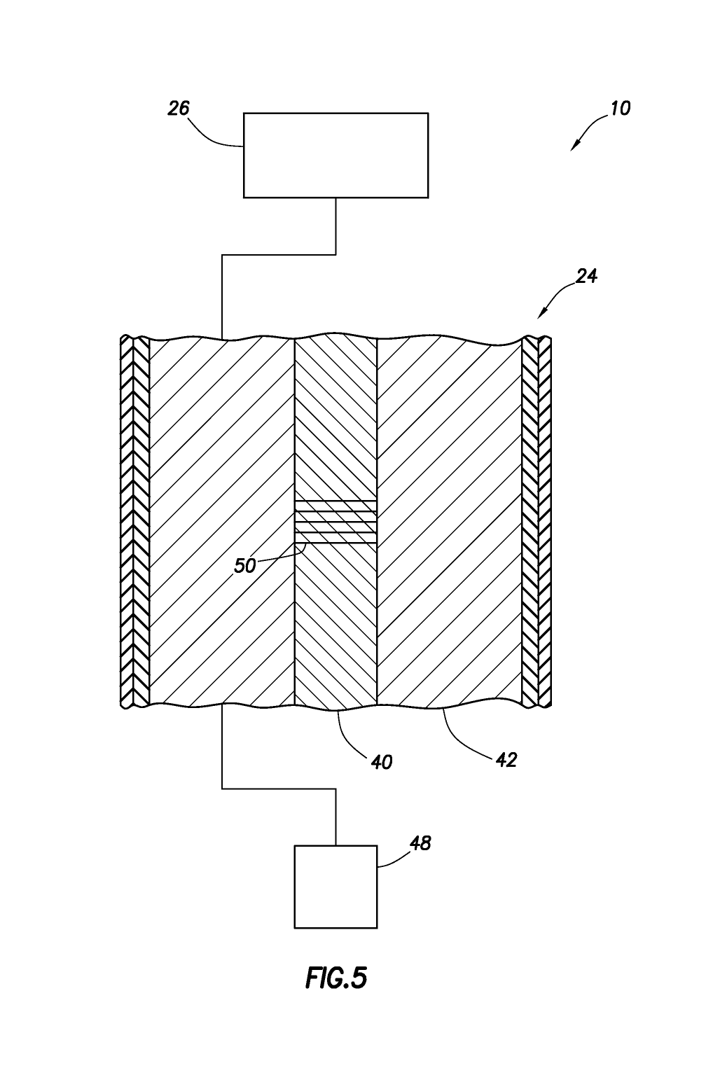

Referring additionally now to FIG. 5, another example of the optical fiber 24 being used in the system 10 is representatively and schematically illustrated. In this example, the inner core 40 is used for sensing a well parameter. The interrogator 26 is optically coupled to the core 40, and the sensor 48 may be optically coupled to the core 40 in the well.

The FIG. 5 example is similar in many respects to the FIG. 4 example, in that the core 40 in the FIG. 5 example may be used as a sensor in the well, and/or the core 40 may be coupled to one or more discrete sensor(s) 48 in the well. One or more fiber Bragg grating(s) 50 may be formed in the core 40.

The same interrogator 26 may be used in the FIG. 5 example as in the FIG. 4 example. Interrogators 26 may be coupled to the respective cores 40, 42 concurrently, in which case one interrogator may be used for one purpose, and another interrogator may be used for another purpose. For example, one interrogator 26 may be used for detecting Raman scattering in one of the cores 40, 42, and another interrogator may be used for detecting Rayleigh or Brillouin scattering in the other core.

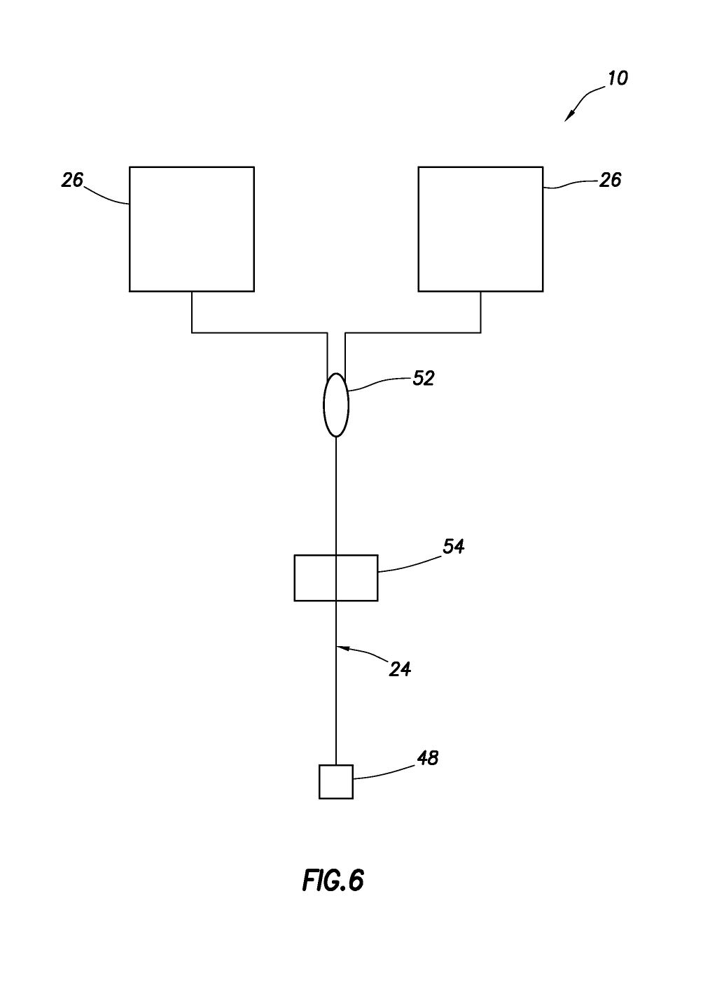

Referring additionally now to FIG. 6, another example of the system 10 is representatively illustrated. In this example, multiple interrogators 26 are optically coupled to the optical fiber 24.

One of the interrogators 26 is coupled to the inner core 40, and the other interrogator is coupled to the outer core 42. An optical coupler 52 is used to couple the interrogators 26 to the respective cores 40, 42.

Note that the optical fiber 24 extends through at least one penetration 54 in the well. The penetration 54 may be in a pressure bulkhead, such as at a wellhead, packer, etc. By incorporating multiple cores 40, 42 into the single optical fiber 24, fewer penetrations 54 are needed, thereby reducing time and expense in installation and maintenance of the system 10.

In one preferred embodiment, a multiple mode core of the fiber 24 may be used for distributed temperature sensing (DTS, e.g., by detection of Raman scatter in the core), and a single mode core may be used for distributed acoustic sensing (DAS, e.g., by detection of Rayleigh and/or Brillouin scatter in the core). In addition, a discrete optical pressure sensor 48 could be optically coupled to the single mode core. Of course, many other embodiments are possible in keeping with the scope of this disclosure.

It may now be fully appreciated that the above disclosure provides significant advancements to the art of optical sensing in wells. In examples described above, multiple cores 40, 42 of the optical fiber 24 may be used in a well to sense multiple well parameters.

A downhole optical sensing system 10 is provided to the art by the above disclosure. In one example, the system 10 can include an optical fiber 24 positioned in the well, the optical fiber 24 including multiple cores 40, 42 and at least one well parameter being sensed in response to light being transmitted via at least one of the multiple cores 40, 42 in the well.

The downhole optical sensing system 10 can include at least one optical interrogator 26 optically coupled to the optical fiber 24. The well parameter is sensed, in this example, further in response to the light being launched into the optical fiber 24 by the interrogator 26.

Scattering of light along the optical fiber 24 may be measured as an indication of the well parameter.

At least one of the multiple cores 40, 42 can be optically coupled to a sensor 48 in the well. The sensor 48 may comprise an interferometer. At least one of the multiple cores 40, 42 may comprise an optical sensor in the well.

One well parameter (e.g., pressure, temperature, strain, vibration, etc.) can be sensed in response to light being transmitted via one of the multiple cores 40, 42, and another well parameter can be sensed in response to light being transmitted via another one of the cores.

Temperature as distributed along the optical fiber 24 in the well can be indicated by scatter of light in one of the multiple cores 40, 42, and acoustic energy as distributed along the optical fiber 24 in the well can be indicated by scatter of light in another one of the cores. A pressure sensor 48 may be optically coupled to the second core. The first core, in this example, may comprise a single mode core and the second core may comprise a multiple mode core.

The multiple cores 40, 42 may comprise a combination of single mode and multiple mode cores, multiple single mode cores, and/or a plurality of multiple mode cores.

A method of sensing at least one well parameter in a subterranean well is also described above. In one example, the method can comprise: transmitting light via at least one of multiple cores 40, 42 of an optical fiber 24 in the well, the at least one of the multiple cores 40, 42 being optically coupled to a sensor 48 in the well, and/or the at least one of the multiple cores 40, 42 comprising a sensor in the well; and determining the at least one well parameter based on the transmitted light.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A downhole optical sensing system, comprising:
an optical fiber positioned in the well, the optical fiber including multiple cores; and
at least one well parameter being sensed in response to light being transmitted via at least one of the multiple cores in the well.

2. The downhole optical sensing system of claim 1, further comprising at least one optical interrogator optically coupled to the optical fiber, the parameter being sensed further in response to the light being launched into the optical fiber by the interrogator.

3. The downhole optical sensing system of claim 1, wherein scattering of light along the optical fiber is measured as an indication of the well parameter.

4. The downhole optical sensing system of claim 1, wherein the at least one of the multiple cores is optically coupled to a sensor in the well.

5. The downhole optical sensing system of claim 4, wherein the sensor comprises an interferometer.

6. The downhole optical sensing system of claim 1, wherein the at least one of the multiple cores comprises an optical sensor in the well.

7. The downhole optical sensing system of claim 1, wherein a first well parameter is sensed in response to light being transmitted via a first one of the multiple cores, and a second well parameter is sensed in response to light being transmitted via a second one of the multiple cores.

8. The downhole optical sensing system of claim 1, wherein the multiple cores comprise a combination of single mode and multiple mode cores.

9. The downhole optical sensing system of claim 1, wherein the multiple cores comprise multiple single mode cores.

10. The downhole optical sensing system of claim 1, wherein the multiple cores comprise a plurality of multiple mode cores.

11. The downhole optical sensing system of claim 1, wherein temperature as distributed along the optical fiber in the well is indicated by scatter of light in a first one of the multiple cores, and wherein acoustic energy as distributed along the optical fiber in the well is indicated by scatter of light in a second one of the multiple cores.

12. The downhole optical sensing system of claim 11, wherein a pressure sensor is optically coupled to the second core.

13. The downhole optical sensing system of claim 11, wherein the first core comprises a single mode core and the second core comprises a multiple mode core.

14. The downhole optical sensing system of claim 13, wherein the multiple mode core surrounds the single mode core.

15. A method of sensing at least one well parameter in a subterranean well, the method comprising:
transmitting light via at least one of multiple cores of an optical fiber in the well, wherein at least one of the following is true: a) the at least one of the multiple cores is optically coupled to a sensor in the well, and b) the at least one of the multiple cores comprises a sensor in the well; and
determining the at least one well parameter based on the transmitted light.

16. The method of claim 15, further comprising optically coupling at least one optical interrogator to the optical fiber, the well parameter being sensed in response to the light being launched into the optical fiber by the interrogator.

17. The method of claim 15, wherein the determining further comprises measuring scattering of light along the optical fiber as an indication of the well parameter.

18. The method of claim 15, wherein the at least one of the multiple cores is optically coupled to the sensor in the well.

19. The method of claim 18, wherein the sensor comprises an interferometer.

20. The method of claim 15, wherein the at least one of the multiple cores comprises the optical sensor in the well.

21. The method of claim 15, wherein a first well parameter is sensed in response to light being transmitted via a first one of the multiple cores, and a second well parameter is sensed in response to light being transmitted via a second one of the multiple cores.

22. The method of claim 15, wherein the multiple cores comprise a combination of single mode and multiple mode cores.

23. The method of claim 15, wherein the multiple cores comprise multiple single mode cores.

24. The method of claim 15, wherein the multiple cores comprise a plurality of multiple mode cores.

25. The method of claim 15, wherein temperature as distributed along the optical fiber in the well is indicated by scatter of light in a first one of the multiple cores, and wherein acoustic energy as distributed along the optical fiber in the well is indicated by scatter of light in a second one of the multiple cores.

26. The method of claim 15, wherein the sensor comprises a pressure sensor optically coupled to the second core.

27. The method of claim 15, wherein the first core comprises a single mode core and the second core comprises a multiple mode core.

28. The method of claim 27, wherein the multiple mode core surrounds the single mode core.

29. A downhole optical sensing system, comprising:
an optical fiber positioned in the well, the optical fiber including multiple cores; and
the multiple cores including a single mode core surrounded by a multiple mode core.

30. The downhole optical sensing system of claim 29, wherein at least one of the multiple cores is optically coupled to a sensor in the well.

31. The downhole optical sensing system of claim 30, wherein the sensor comprises an interferometer.

32. The downhole optical sensing system of claim 29, wherein at least one of the multiple cores comprises an optical sensor in the well.

33. The downhole optical sensing system of claim 29, wherein a first well parameter is sensed in response to light being transmitted via the single mode core, and a second well parameter is sensed in response to light being transmitted via the multiple mode core.

34. The downhole optical sensing system of claim 29, wherein temperature as distributed along the optical fiber in the well is indicated by scatter of light in the multiple mode core, and wherein acoustic energy as distributed along the optical fiber in the well is indicated by scatter of light in the single mode core.

35. The downhole optical sensing system of claim 34, wherein a pressure sensor is optically coupled to the second core.

36. The downhole optical sensing system of claim 29, wherein at least one well parameter is sensed in response to light being transmitted via at least one of the multiple cores in the well.

37. The downhole optical sensing system of claim 36, further comprising at least one optical interrogator optically coupled to the optical fiber, the parameter being sensed further in response to the light being launched into the optical fiber by the interrogator.

38. The downhole optical sensing system of claim 36, wherein scattering of light along the optical fiber is measured as an indication of the well parameter.
